(19) United States
(12) Patent Application Publication
(10) Pub. No.: US 2025/0189722 A1
(43) Pub. Date: Jun. 12, 2025

(54) WAVEGUIDE ELEMENT

(71) Applicant: AUO Corporation, Hsinchu City (TW)

(72) Inventors: Yu-Ting HU, Hsinchu City (TW); Ming-Jui Wang, Hsinchu City (TW); Chih-Chiang Chen, Hsinchu City (TW); Chia-Hsin Chung, Hsinchu City (TW); Cheng-Chan Wang, Hsinchu City (TW); Hsin-Chang Lin, Hsinchu City (TW)

(21) Appl. No.: 18/950,246

(22) Filed: Nov. 18, 2024

(30) Foreign Application Priority Data
Dec. 8, 2023 (TW) 112148003

(51) Int. Cl. G02B 6/122; G02B 6/10; G02B 6/12

(52) U.S. Cl. CPC G02B 6/1228; G02B 6/107; G02B 6/1223; G02B 2006/12107; G02B 2006/12147

(57) ABSTRACT

A waveguide element includes a substrate and a grating structure. The grating structure is located on the substrate to form a light in-coupling area, a light out-coupling area and a light pupil expanding area, in which the light pupil expanding area optically couples the light in-coupling area and the light out-coupling area. The light pupil expanding area has at least two partitions, and an included angle ϕ is between a border of the partitions of the light pupil expanding area and a horizontal line. The included angle ϕ satisfies

$$ϕ = {tan}^{- 1} ( \frac{{β}_{1}}{{α}_{1}} ) ,$$

in which α₁=(−λ sin ψ+αd)/nd, β₁=(λ cos ψ+βd)/nd, α=sin(θ)×cos ψ, β=sin(θ)×sin ψ, λ is a wavelength of an incident light, θ is a field of view, n is a refractive index of the substrate, ψ is a grating vector direction of the light in-coupling area, and d is a grating periodic distance of the light in-coupling area.

### RELATED APPLICATIONS

This application claims priority to Taiwan Application Serial Number 112148003, filed Dec. 8, 2023, which is herein incorporated by reference.

### BACKGROUND

### Technical Field

The present disclosure relates to a waveguide element.

### Description of Prior Art

In augmented reality (AR) displays, one of the most important technologies is to use a waveguide element based on a diffractive optical element to expand an image. The expansion of the image in either one-dimensional or two-dimensional direction contributes to the wearing comfortability of a device.

However, the expansion of the image involves the distribution of energy of the images in a two-dimensional space, but the farther away from an image input place is, the more serious the degradation of the energy of the image is, thus affecting the uniformity of the image.

### SUMMARY

One technical aspect of the present disclosure is a waveguide element.

According to an embodiment of the present disclosure, a waveguide element includes a substrate and a grating structure. The grating structure is located on the substrate to form a light in-coupling area, a light out-coupling area and a light pupil expanding area, wherein the light pupil expanding area optically couples the light in-coupling area and the light out-coupling area; the light pupil expanding area is configured to receive a light beam from the light in-coupling area and to diffract and to expand the light beam towards the light out-coupling area; the light pupil expanding area has at least two partitions, and an included angle ϕ is between a border of the partitions of the light pupil expanding area and a horizontal line; the included angle ϕ satisfies

$$ϕ = {tan}^{- 1} ( \frac{{β}_{1}}{{α}_{1}} ) ,$$

wherein α₁=(−A sin ψ+αd)/nd, β₁=(λ cos ψ+βd)/nd, α=sin(θ)×cos ψ, β=sin(θ)×sin ψ, λ is a wavelength of an incident light, θ is a field of view, n is a refractive index of the substrate, ψ is a grating vector direction of the light in-coupling area, and d is a grating periodic distance of the light in-coupling area.

In an embodiment of the present disclosure, the included angle ϕ between the border of the partitions of the light pupil expanding area and the horizontal line has an offset, and the offset is less than or equal to 10 degrees.

In an embodiment of the present disclosure, the grating structure includes a plurality of gratings, each of the gratings of the partitions of the light pupil expanding area has a grating height, and the grating heights increase progressively in a direction from the partition closest to the light in-coupling area to the partition furthest away from the light in-coupling area.

In an embodiment of the present disclosure, the grating heights are 10-300 nm.

In an embodiment of the present disclosure, each of the partitions of the light pupil expanding area has a filling ratio, and the filling ratios decrease progressively in the direction from the partition closest to the light in-coupling area to the partition furthest away from the light in-coupling area.

In an embodiment of the present disclosure, the grating structure includes a plurality of gratings, an inclined angle is between each of the gratings of the light pupil expanding area and the horizontal surface of the substrate, and the inclined angles decrease progressively in the direction from the partition closest to the light in-coupling area to the partition furthest away from the light in-coupling area.

In an embodiment of the present disclosure, the grating periodic distance is 300-1200 nm.

In an embodiment of the present disclosure, the refractive index of the substrate is 1.5-2.5, and a refractive index of the grating structure is 1.2-2.5.

In an embodiment of the present disclosure, the field of view is 0-90 degrees.

In an embodiment of the present disclosure, the wavelength of the incident light is 400-700 nm.

In an embodiment of the present disclosure, since the light pupil expanding area has at least two partitions, and the included angle between the border of the partitions of the light pupil expanding area and the horizontal line is specially calculated, the included angle is related to parameters such as the wavelength of the incident light, the field of view, the refractive index of the substrate, the grating vector direction of the light in-coupling area, and the grating periodic distance of the light in-coupling area, so that the energy can be distributed more evenly during pupil expanding, thereby improving the uniformity of pictures.

### BRIEF DESCRIPTION OF THE DRAWINGS

Aspects of the present disclosure may be best understood from subsequent embodiments when read in conjunction with the drawings. Note that, in accordance with standard practices in this industry, various features are not drawn to scale. In fact, the dimensions of the various features may be arbitrarily increased or decreased for clarity of argument.

FIG. 1 shows a top view of a waveguide element according to an embodiment of the present disclosure;

FIG. 2 shows a side view of the waveguide element and a light source according to an embodiment of the present disclosure;

FIG. 3 shows a locally enlarged top view of a light in-coupling area of the waveguide element in FIG. 1;

FIG. 4 shows a locally enlarged top view of a light pupil expanding area of the waveguide element in FIG. 1;

FIGS. 5 and 6 show locally enlarged section views of a grating structure of the waveguide element in FIG. 1;

FIG. 7 shows a top view of a waveguide element and a light source according to another embodiment of the present disclosure; and

FIG. 8 shows a top view of a waveguide element and a light source according to still another embodiment of the present disclosure.

### DETAILED DESCRIPTION

The following embodiments of the present disclosure provide a number of different embodiments, or examples, for implementing different characteristics of the subject matter provided. Specific examples of components and arrangements are described below to simplify the case. Obviously, these examples are examples only and are not intended as limitations. In addition, component symbols and/or letters may be repeated in each example of the case. Such repetition is intended for the purpose of simplicity and clarity, and does not itself specify the relationship between the various embodiments and/or configurations discussed.

Spatial relative terms such as “below”, “under”, “lower”, “above” and “upper” may be used for descriptive purposes herein to describe the relation of one element or feature to another as shown in the drawings. The spatial relative terms are intended to encompass different orientations of devices in use or operation other than those shown in the drawings. The devices may be oriented in other ways (to rotate 90 degrees or otherwise) and spatial relative descriptors used herein may be interpreted accordingly.

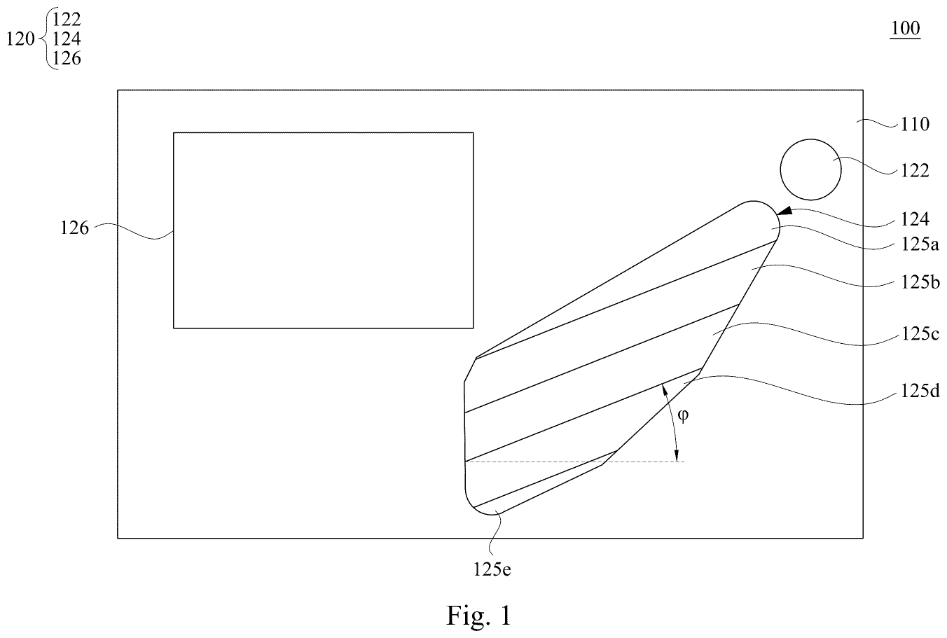

FIG. 1 shows a top view of a waveguide element 100 according to an embodiment of the present disclosure. Referring to FIG. 1, a waveguide element 100 includes a substrate 110 and a grating structure 120. The grating structure 120 is located on the substrate 110 to form a light in-coupling area 122, a light pupil expanding area 124 and a light out-coupling area 126, where the light pupil expanding area 124 optically couples the light in-coupling area 122 and light out-coupling area 126. In the present embodiment, the light in-coupling area 122 is located in the upper right corner of the waveguide element 100, the light out-coupling area 126 is located in the upper left corner of the waveguide element 100, and the light pupil expanding area 124 is located below the middle of the waveguide element 100.

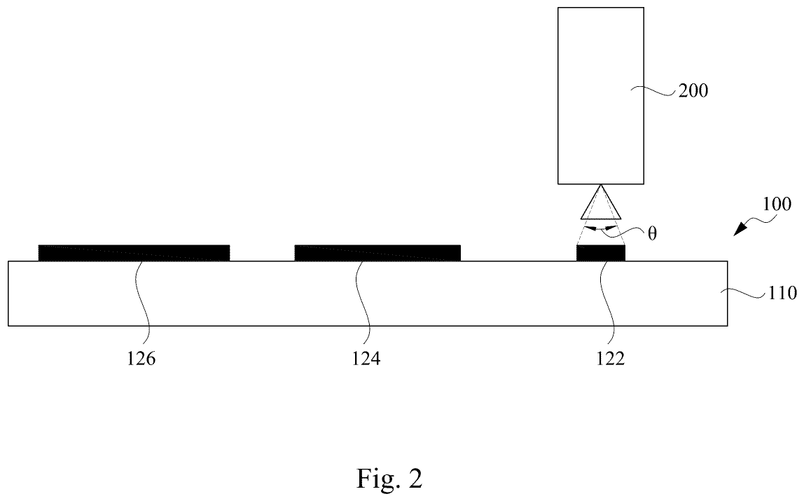

The light pupil expanding area 124 is configured to receive a light beam from the light in-coupling area 122 and to diffract and to expand the light beam towards the light out-coupling area 126. In FIG. 1, the light pupil expanding area 124 has five partitions: 125a, 125b, 125c, 125d and 125e, and an included angle ϕ is between each of borders of the partitions 125a, 125b, 125c, 125d and 125e of the light pupil expanding area and a horizontal line. The included angle ϕ satisfies

$$ϕ = {tan}^{- 1} ( \frac{{β}_{1}}{{α}_{1}} ) ,$$

where α₁=(−λ sin ψ+αd)/nd, β₁=(λ cos ψ+βd)/nd, α=−sin(θ)×cos ψ, β=sin(θ)×sin ψ, λ is a wavelength of an incident light, θ is a field of view, n is a refractive index of the substrate 110, ψ is a grating vector direction of the light in-coupling area 122, and d is a grating periodic distance of the light in-coupling area 122. The parameters (the wavelength of the incident light, the field of view, the refractive index of the substrate, the grating vector direction of the light in-coupling area, and the grating periodic distance of the light in-coupling area) are determined by each part of the waveguide element 100 and a light source used (will be described in detail in FIG. 2).

FIG. 2 shows a side view of the waveguide element 100 and a light source 200 according to an embodiment of the present disclosure. Referring to FIGS. 1 and 2, when the waveguide element 100 is used to receive an image from the light source 200, a wavelength and a field of view of the image are determined by the light source 200. In terms of color display, it can be understood that in order to display different colored images, a wavelength of an incident light is not a constant value, but a range. For example, in some embodiments, the wavelength of the incident light is 400-700 nm. Such design results in that the calculated included angle ϕ is a range as well, and therefore, it can be understood that the included angle ϕ between each of borders of the partitions 125a, 125b, 125c, 125d and 125e of the light pupil expanding area 124 and the horizontal line has an offset, and the offset is less than or equal to 10 degrees. In addition, in some embodiments, a field of view θ of the incident light is 0-90 degrees. The field of view θ is also a design parameter, since only if a light beam emitted by the light source 200 must enter the light in-coupling area 122, the light in-coupling area 122 transmits the light beam to the light pupil expanding area 124 that optically couples the light in-coupling area 122. In addition, a refractive index of the substrate 110 also determines the included angle ϕ, and in some embodiments, the refractive index of the substrate 110 is 1.5-2.5. In the following description, the light in-coupling area 122 of the grating structure 120 will be described in detail.

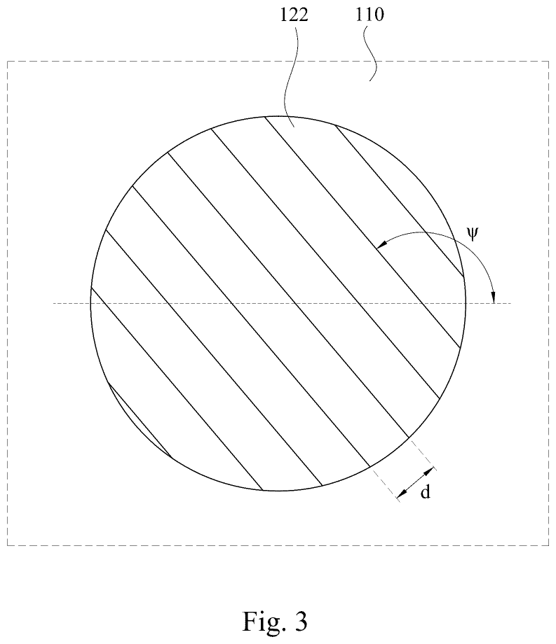

FIG. 3 shows a locally enlarged top view of the light in-coupling area 122 of the waveguide element 100 in FIG. 1. Referring to FIG. 3, when the included angle ϕ between each of the borders of the partitions 125a, 125b, 125c, 125d and 125e of the light pupil expanding area 124 and the horizontal line is determined, there are two parameters determined by the light in-coupling area 122, i.e., a grating vector direction ψ of the light in-coupling area 122 and a grating periodic distance d of the light in-coupling area 122. Here, the grating vector direction ψ is an included angle between an extension direction of a gap of the grating and the horizontal line, the horizontal line and the horizontal line mentioned in the included angle ϕ can be the same or parallel to each other. The periodic distance d refers to a distance at which the grating repeats once. In some embodiments, the grating periodic distance d is 300-1200 nm. In addition, in some embodiments, the grating vector direction ψ is 0-360 degrees. Different from the above wavelength of the incident light, the grating vector direction ψ and the grating periodic distance d of the light in-coupling area 122 are constant values after the design of the light in-coupling area 122 is completed. In the following description, the light pupil expanding area 124 of the grating structure 120 will be described in detail.

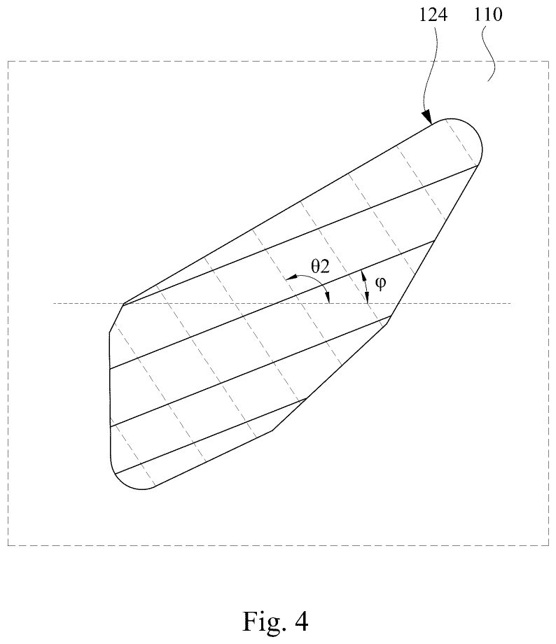

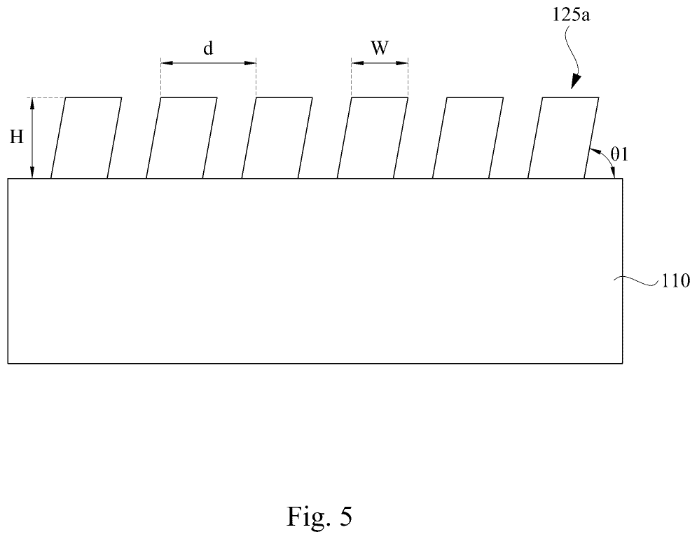

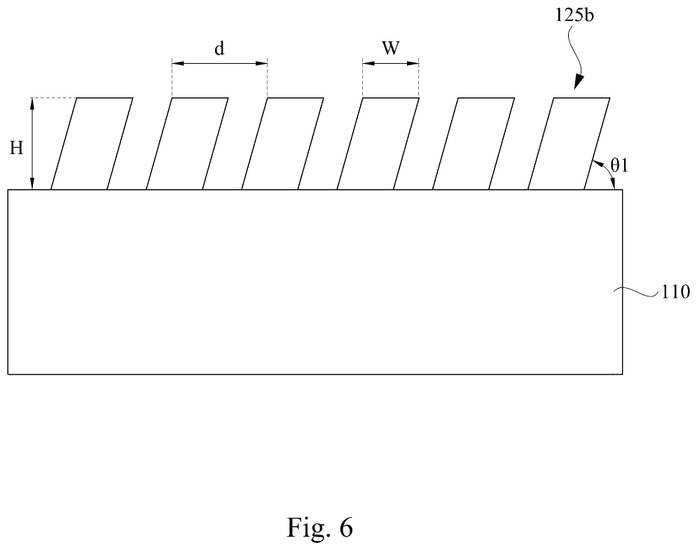

FIG. 4 shows a locally enlarged top view of the light pupil expanding area 124 of the waveguide element 100 in FIG. 1. FIGS. 5 and 6 show locally enlarged section views of the partitions 125a and 125b in the grating structure 120 of the waveguide element 100 in FIG. 1. Referring to FIGS. 4, 5 and 6, there are several ways to separate the partitions 125a, 125b, 125c, 125d and 125e during partitioning such that the partitions 125a, 125b, 125c, 125d and 125e are different in optical properties. The included angle ϕ between each of the borders of the partitions 125a, 125b, 125c, 125d and 125e and the horizontal line is not the same as an included angle 62 between the grating and the horizontal line, and the two included angles are two independent parameters, which are clearly stated firstly. In some embodiments, the gratings of the partitions 125a, 125b, 125c, 125d and 125e of the light pupil expanding area 124 each have a grating height H, and the grating heights H increase progressively in a direction from the partition 125a closest to the light in-coupling area 122 to the partition 125e furthest away from the light in-coupling area 122.

In addition, in some embodiments, each of the partitions 125a, 125b, 125c, 125d and 125e of the light pupil expanding area 124 has a filling ratio, and the filling ratios decrease progressively in the direction from the partition 125a closest to the light in-coupling area 122 to the partition 125e furthest away from the light in-coupling area 122. The so-called “filling ratio” here refers to a division of the grating width W by the grating periodic distance d, which means that the wider a line width of the grating is, the higher the filling ratio is. In addition, in some embodiments, the grating structure 120 includes a plurality of gratings, an inclined angle 61 is between each of the gratings of the light pupil expanding area 124 and the horizontal surface of the substrate 110, and the inclined angles 61 decrease progressively in the direction from the partition 125a closest to the light in-coupling area 122 to the partition 125e furthest away from the light in-coupling area 122. Such design causes the refractive index of each of the partitions 125a, 125b, 125c, 125d and 125e of the light pupil expanding area 124 to be distributed discontinuously, and thus the energy of the incident light can be released to the light out-coupling area 126 in different times. In some embodiments, the refractive index of the grating structure 120 is 1.2-2.5.

Since the light pupil expanding area 124 has the partitions 125a, 125b, 125c, 125d and 125e, and the included angle between each of the bonders of the partitions 125a, 125b, 125c, 125d and 125e and the horizontal line is specially calculated, the included angle is related to parameters such as the wavelength of the incident light, the field of view θ, the refractive index of the substrate 110, the grating vector direction ψ of the light in-coupling area 122, and the grating periodic distance of the light in-coupling area 122, so that the energy can be distributed more evenly during pupil expanding, thereby improving the uniformity of pictures.

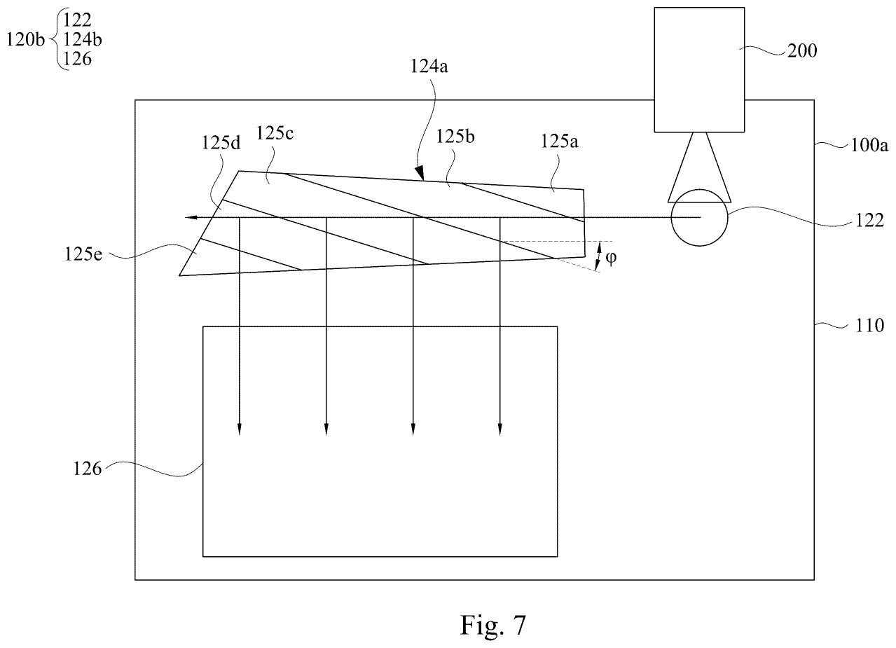

FIG. 7 shows a top view of a waveguide element 100a and a light source 200 according to another embodiment of the present disclosure. Referring to FIG. 7, a waveguide element 100a includes a substrate 110 and a grating structure 120a. The grating structure 120a is located on the substrate 110 to form a light in-coupling area 122, a light out-coupling area 126 and a light pupil expanding area 124a, where the light pupil expanding area 124a optically couples the light in-coupling area 122 and the light out-coupling area 126. The present embodiment differs from the embodiment in FIG. 1 in the position arrangement of the light out-coupling area 126 and the light pupil expanding area 124a of the grating structure 120a. The light out-coupling area 126 is located in the lower left corner and below the middle of the waveguide element 100a, and the light pupil expanding area 124a is located in the upper left corner and above the middle of the waveguide element 100a. In addition, the light source 200 in the present embodiment is a single-wavelength light source with a fixed wavelength of 550 nm. Wavelength and other parameters are shown in Table 1:

TABLE 1

| Parameters | Numerical Value |
|---|---|
| Wavelength of an incident light | 550 nm |
| Field of view | 40° |
| Refractive index of the substrate | 1.89 |
| Grating vector direction of the | 90° |
| light in-coupling area | |
| Grating periodic distance of the | 300 nm |
| light in-coupling area | |
| Included angle φ (calculated) | −19.3° |

In the present embodiment, the partitions 125a, 125b, 125c, 125d and 125e of the light pupil expanding area 124a are distinguished by the grating height H of the grating in each of the partitions 125a, 125b, 125c, 125d and 125e. In the present embodiment, the grating heights of the five partitions 125a, 125b, 125c, 125d and 125e are 5 nm, 15 nm, 60 nm, 90 nm, and 120 nm, respectively.

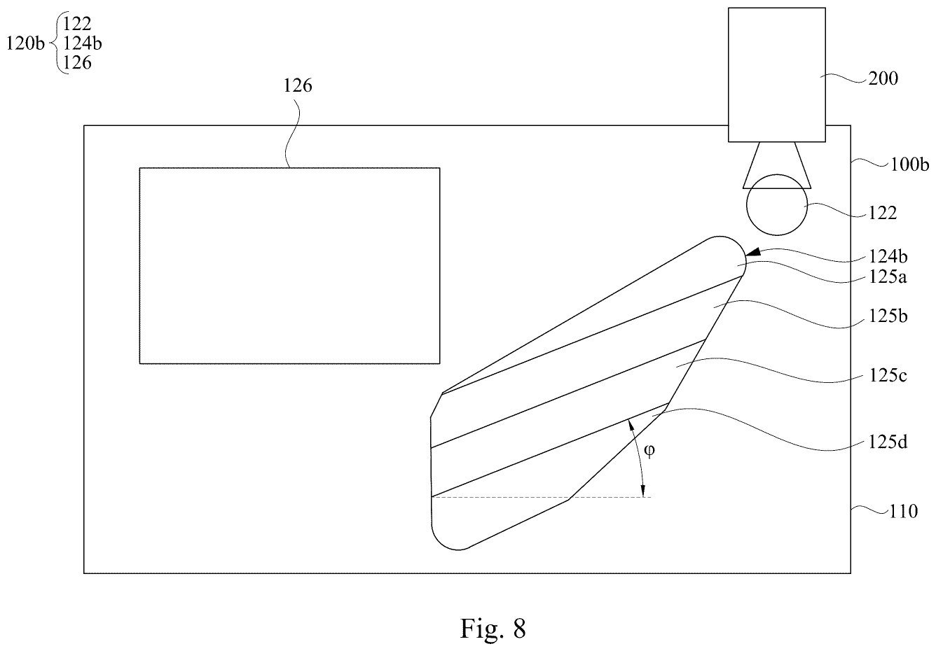

FIG. 8 shows a top view of a waveguide element 100b and a light source 200 according to still another embodiment of the present disclosure. Referring to FIG. 8, a waveguide element 100a includes a substrate 110 and a grating structure 120b. The grating structure 120 is located on the substrate 110 to form a light in-coupling area 122, a light out-coupling area 126 and a light pupil expanding area 124b, where the light pupil expanding area 124b optically couples the light in-coupling area 122 and light out-coupling area 126. The present embodiment differs from the embodiment in FIG. 1 in that in the present embodiment, the light pupil expanding area 124b has only four partitions 125a, 125b, 125c and 125d. In addition, the light source 200 in the present embodiment is a light source 200 capable of emitting a plurality of wavelengths, and the design parameters of the present embodiment are shown in Table 2:

TABLE 2

| Parameters | Numerical Value |
|---|---|
| Wavelength of an incident light | 460 nm, 525 nm, 625 nm |
| Field of view | 30° |
| Refractive index of the substrate | 1.817 |
| Grating vector direction of the | 130° |
| light in-coupling area | |
| Grating periodic distance of the | 350 nm |
| light in-coupling area | |
| Included angle φ (calculated) | 22° (calculated in 525 nm) |
| Offset | 5° |

In the present embodiment, the partitions 125a, 125b, 125c, 125d of the light pupil expanding area 124b are distinguished by the grating height H of the grating in each of the partitions 125a, 125b, 125c, 125d. In the present embodiment, the grating heights of the four partitions of 125a, 125b, 125c and 125d are 20 nm, 40 nm, 60 nm, and 80 nm, respectively.

The foregoing outlines the features of several embodiments so that those skilled in the art may better understand the aspects of the present disclosure. Those skilled in the art should understand that they can easily use the present disclosure as a basis for designing or modifying other processes and structures to achieve the same purposes and/or to achieve the same advantages as the embodiments described herein. Those skilled in the art should also be aware that such equivalent constructions are not divorced from the spirit and scope of the present disclosure, and that, without deviating from the spirit and scope of the present disclosure, they may be subject here to various alterations, substitutions and alterations.

What is claimed is:

1. A waveguide element, comprising:
a substrate; and
a grating structure located on the substrate to form a light in-coupling area, a light out-coupling area and a light pupil expanding area, wherein the light pupil expanding area optically couples the light in-coupling area and the light out-coupling area; the light pupil expanding area is configured to receive a light beam from the light in-coupling area and to diffract and to expand the light beam towards the light out-coupling area; the light pupil expanding area has at least two partitions, and an included angle ϕ is between a border of the partitions of the light pupil expanding area and a horizontal line; the included angle ϕ satisfies
$$ϕ = {tan}^{- 1} ( \frac{{β}_{1}}{{α}_{1}} ) ,$$
wherein α₁=(−λ sin ψ+αd)/nd, β₁(λ cos ψ+βd)/nd, α=sin(θ)×cos ψ, β=sin(θ)×sin ψ, λ is a wavelength of an incident light, θ is a field of view, n is a refractive index of the substrate, ψ is a grating vector direction of the light in-coupling area, and d is a grating periodic distance of the light in-coupling area.

2. The waveguide element according to claim 1, wherein the included angle ϕ between the border of the partitions of the light pupil expanding area and the horizontal line has an offset, and the offset is less than or equal to 10 degrees.

3. The waveguide element according to claim 1, wherein the grating structure comprises a plurality of gratings, each of the gratings of the partitions of the light pupil expanding area has a grating height, and the grating heights increase progressively in a direction from the partition closest to the light in-coupling area to the partition furthest away from the light in-coupling area.

4. The waveguide element according to claim 3, wherein the grating heights are 10-300 nm.

5. The waveguide element according to claim 1, wherein each of the partitions of the light pupil expanding area has a filling ratio, and the filling ratios decrease progressively in the direction from the partition closest to the light in-coupling area to the partition furthest away from the light in-coupling area.

6. The waveguide element according to claim 1, wherein the grating structure comprises a plurality of gratings, an inclined angle is between each of the gratings of the light pupil expanding area and a horizontal surface of the substrate, and the inclined angles decrease progressively in the direction from the partition closest to the light in-coupling area to the partition furthest away from the light in-coupling area.

7. The waveguide element according to claim 1, wherein the grating periodic distance is 300-1200 nm.

8. The waveguide element according to claim 1, wherein the refractive index of the substrate is 1.5-2.5, and a refractive index of the grating structure is 1.2-2.5.

9. The waveguide element according to claim 1, wherein the field of view is 0-90 degrees.

10. The waveguide element according to claim 1, wherein the wavelength of the incident light is 400-700 nm.

11. A waveguide element, comprising:
a substrate; and
a grating structure located on the substrate to form a light in-coupling area, a light out-coupling area and a light pupil expanding area, wherein the light pupil expanding area optically couples the light in-coupling area and the light out-coupling area; the light pupil expanding area has at least two partitions, and an included angle ϕ is between a border of the partitions of the light pupil expanding area and a horizontal line; the included angle ϕ satisfies
$$ϕ = {tan}^{- 1} ( \frac{{β}_{1}}{{α}_{1}} ) ,$$
wherein α₁=(−λ sin ψ+αd)/nd, β₁=(λ cos ψ+βd)/nd, α=sin(θ)×cos ψ, β=sin(θ)×sin ψ, λ is a wavelength of an incident light, θ is a field of view, n is a refractive index of the substrate, ψ is a grating vector direction of the light in-coupling area, d is a grating periodic distance of the light in-coupling area, the included angle ϕ between the border of the partitions of the light pupil expanding area and the horizontal line has an offset, and the offset is less than or equal to 10 degrees.

12. The waveguide element according to claim 11, wherein the grating structure comprises a plurality of gratings, each of the gratings of the partitions of the light pupil expanding area has a grating height, and the grating heights increase progressively in a direction from the partition closest to the light in-coupling area to the partition furthest away from the light in-coupling area.

13. The waveguide element according to claim 12, wherein the grating heights are 10-300 nm.

14. The waveguide element according to claim 11, wherein each of the partitions of the light pupil expanding area has a filling ratio, and the filling ratios decrease progressively in the direction from the partition closest to the light in-coupling area to the partition furthest away from the light in-coupling area.

15. The waveguide element according to claim 11, wherein the grating structure comprises a plurality of gratings, an inclined angle is between each of the gratings of the light pupil expanding area and a horizontal surface of the substrate, and the inclined angles decrease progressively in the direction from the partition closest to the light in-coupling area to the partition furthest away from the light in-coupling area.
